(19) United States
(12) Patent Application Publication
(10) Pub. No.: US 2011/0208581 A1
(43) Pub. Date: Aug. 25, 2011

(54) ONLINE ADVERTISING

(75) Inventor: Gregory Roebuck, Victoria (AU)

(73) Assignee: CARSALES.COM LIMITED, Hawthorn, Victoria (AU)

(21) Appl. No.: 13/057,813

(22) PCT Filed: Aug. 7, 2009
(86) PCT No.: PCT/AU2009/001014

§ 371 Date: May 9, 2011

(30) Foreign Application Priority Data
Aug. 7, 2008 (AU) 2008904048

(51) Int. Cl. G06Q 30/00

(52) U.S. Cl. 705/14.49

(57) ABSTRACT

Systems and methods are used to deliver advertisements online to an Internet user. A database records advertiser specified criteria for the delivery of one or more advertisements to an Internet user. A server is operable to receive a collection of material for delivery to a user, where the collection of material resulting from the user having conducted activity on the Internet, and to analyse the collection of material according to the specified criteria. The server is further operable in the event the criteria are met, to deliver an advertisement specified by the advertiser together with at least a portion of the collection of material.

### CROSS-REFERENCE TO RELATED APPLICATIONS

The present application claims priority from Australian Provisional Patent Application No 2008904048 filed on 7 Aug. 2008, the content of which is incorporated herein by reference.

### TECHNICAL FIELD

This invention concerns online advertising and in particular advertising together with other content delivered to an Internet user.

### BACKGROUND ART

In many well known Internet search engines “advertisements” are delivered together with search results. For instance, a search might be conducted by entering the keywords “PATENT ATTORNEY AUSTRALIA”. The result might include a list of links to relevant websites (strictly speaking the result has links to individual webpages), for instance a patent attorney directory, the Institute of Patent Attorneys and the sites of various firms of Australian patent attorneys. In addition a list of sponsored links or “advertisements” may also be delivered.

The sponsored links are retrieved as a result of the advertisers “buying” keywords from the search engine. The ordered combination of the three keywords presented above may be purchased or, at greater cost, one or more single keywords may be purchased. Typically there is no payment made at the time of “purchase”, but payment is required in response to click-through to the advertiser's site. The quantum of the payment is typically based on a formula related to the keywords. This type of online advertising requires the advertiser to anticipate the keywords that users will enter when they might be in the market for the advertised products or services.

Another prevalent form of advertising on the Internet is embedded advertisements in third parties web pages. The owner of a website may choose to sell an area of a page in their site where third parties can advertise to people visiting the site. Typically these advertisements are not static, but change quite rapidly according to a schedule. Relevancy is achieved by choosing to display advertisements related to the content of the page where it is embedded.

### SUMMARY OF THE INVENTION

In one aspect, the invention is a computer implemented method of delivering advertisements online to an Internet user, the method comprising:

an advertiser specifying criteria for the delivery of an advertisement to an Internet user;

the user conducting activity on the Internet that results in a collection of material for delivery to the user; and

analysing the collection of material according to the advertiser specified criteria, and in the event the specified criteria are met, delivering an advertisement specified by the advertiser together with the delivery of at least a portion of the collection of material.

The specified criteria may comprise at least one field of information with the, or each, field of information including a single word (term) or a set of words (terms) present either alone or in combination in the collection of material. Alternatively, or in addition, the criteria might include an analysis of how many times a particular field or fields of information are repeated in the collection of material.

In addition, the specified criteria may include an inequality associated with the at least one field of information. The specified criteria may additionally comprise specifying a percentage of results that match the inequality. In a non limiting example the specified criteria may include fields such as “engine size greater than x litres”, and the percentage may be specified to be at least 60%. In such a non-limiting example the advertisement would be delivered if at least 60% of the collected material returned results having an engine size greater than x litres.

The advertisements that are presented by the invention have the advantage that they are relevant to the collection of other material being delivered to the user, rather than being independently generated solely from user entered keywords. If the content of the other material is not relevant (subject to the advertiser specified criteria), even if the user intended it to be, then the advertisement will not be shown.

Further specified criteria and/or fields of information may in addition, or optionally comprise synonyms of the words present in the collection of material and/or a set of words matching the context of the collection of material.

In a preferred embodiment, the specified criteria comprises a plurality of fields of information. Each of the fields may be related. In the preferred, or an alternative embodiment where the specified criteria includes an inequality, combinations of fields may be combined to determine whether the specified criteria are met. For instance, in a non limiting example the specified criteria may include fields associated with motorcycles such as “engine size”, “kilowatts”, “fuel consumption”, “fuel tank size”, “seats”, the inequality may be “engine size greater than one litre” and the percentage “at least 70%”. It should be appreciated that certain fields can be combined to determine whether or not an advertisement is to be delivered with the delivery of the collection of material.

Having delivered an advertisement together with the delivery of the collection of material, the method may further comprise deriving revenue from the associated advertiser.

The advertiser may specify criteria for the delivery of more than one advertisement with the criteria for each advertisement being distinct. If the analysis of the collection of material results in the specified criteria matching more than one advertisement the method may further comprise determining which of those matched advertisements are to be delivered to the user. The determination may be based on the greatest revenue which the respective advertisements generate.

The user's activity might include searching, and in this case, the collection of material involves the content of some or all of pages retrieved in response to the search query. The collection of material may also include advertisements retrieved in response to the search query, or advertisements retrieved in response to the content of some or all of pages retrieved based on the search query. The user's activity may include entering a search query and the collection of material may include web-pages retrieved from a selection of the results of the search query. The selection may comprise all of the results of the search query, a percentage of the results of the search query (for example an upper percentile, such as, but not limited to, the top 5% or 10% of the results of the search query).

In another aspect, the invention is a system of delivering advertisements online to an Internet user, the system comprising:

a database to record advertiser specified criteria for the delivery of an advertisement to an Internet user; and

a server operable to:

retrieve a collection of material for delivery to a user, the collection of material resulting from the user having conducted activity on the Internet, and

analyse the collection of material according to the specified criteria, and in the event the advertiser specified criteria are met, to deliver an associated advertisement specified by the advertiser together with the delivery of the collection of material.

The specified criteria may comprise at least one field of information with the, or each, field of information including a single word (or term, topic or category) or a set of words present either alone or in combination in the collection of material. Alternatively, or in addition, the criteria might include an analysis of how many times a particular field or fields of information are repeated in the collection of material.

In addition, the specified criteria may include an inequality associated with the at least one field of information. The specified criteria may additionally comprise specifying a percentage of results that match the inequality.

The server may comprise a search engine module which provides a user interface to enable users to perform searches. The server may further comprise an advert creation module to enable advertisers to create advertisements. Advertisements may be compiled using one or more electronic formats selected from text, image, audio and video. The server may comprise an advertising delivery module to deliver to the user the advertisement specified by the advertiser together with the delivery of the collection of material. The database may maintain a lookup structure, index or the like including a history of all URLs visited during analysis of the collection of material. The lookup structure or index may be stored to the database. The server may comprise a billing engine module to bill an advertiser once having delivered that advertiser's advertisement together with the delivery of the collection of material.

In another aspect, the invention is a computer program for delivering advertisements online to an Internet user, the computer program comprising:

code to record advertiser specifying criteria for the delivery of an advertisement to an Internet user;

code to retrieve a collection of material for delivery to a user, the collection of material resulting from the user having conducted activity on the Internet, and to analyse the received collection of material according to the advertiser specifying criteria, and in the event the advertiser specifying criteria are met, to deliver an advertisement specified by the advertiser together with the delivery of the collection of material.

The computer program may comprise code to generate an automatic script which is scheduled to visit web-pages and analyse the contents thereof. The computer program may further comprise code to create a searchable look up structure of web-pages visited.

### BRIEF DESCRIPTION OF THE DRAWINGS

An example of the invention will now be described with reference to the accompanying drawings, in which:

FIG. 1 is a diagram of an online advertising system exemplifying the invention;

FIG. 2 is a flowchart of an advertisement delivery method;

FIG. 3 is a sample advertisement delivery interface; and

FIG. 4 is a flowchart of the steps involved in the analysis of the collection of material.

### BEST MODES OF THE INVENTION

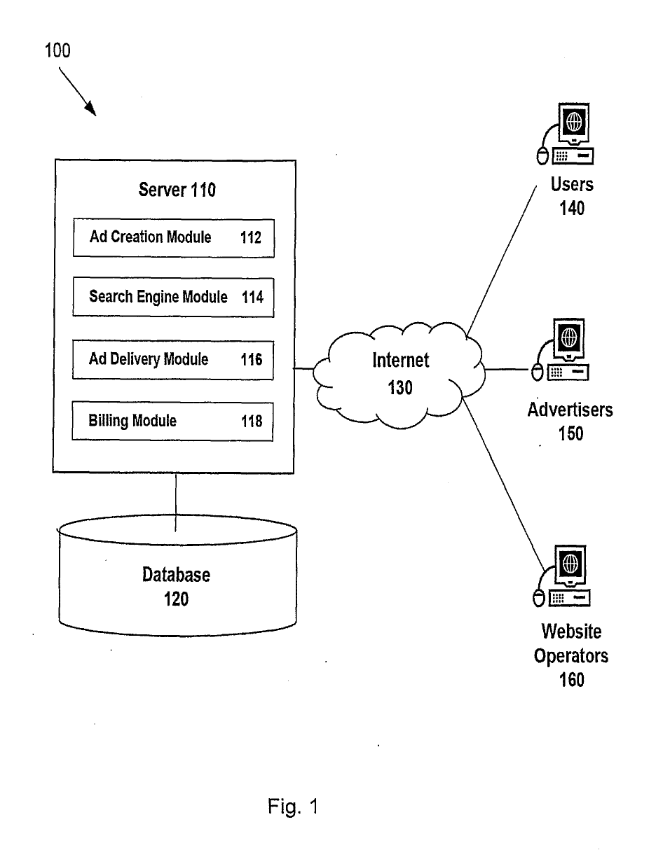

Referring first to FIG. 1, the online advertising system 100 exemplifying the invention comprises a server 110 and a database 120 in communication with a plurality of users 140, advertisers 150 and website operators 160 via the Internet 130. The server 110 runs a number of modules, 112 to 118, to facilitate online advertising.

Ad Creation Module 112 provides a user interface for advertisers 150 to create advertisements in various electronic formats, including text, image, audio, video, animation, and any combination of them. Advertisements are delivered to users 140, who are also advertisement consumers, when they are conducting activity on the Internet according criteria specified by the advertiser. The user's activity could be any activity that results in a collection of material being sent to the user's computer, or specifically the user's Internet browser. This includes performing a search on the Internet. Users 140 may access the server 110 using a computer or a wireless device.

Advertisers 150 are required to specify the criteria for delivery of an advertisement when the advertisement is created, which include one or more of:

one or more fields of information, which may be a set of words present either alone, or in combination, in the collection of material;

a set of fields of information present in a percentage of the collection of material, such as more than 50% of the collection of material;

synonyms of the fields of information present in the collection of material;

a set of fields of information matching the context of the collection of material,

an analysis of how many times a particular field or fields of information are repeated in the collection of material, and the proximity of those fields of information in the collection of material;

inequalities present in the collection of material; and

statistical properties of the material, such as feature vectors of images, audio and video files, in the collection of material.

It should be appreciated that advertiser specified criteria which includes words, or terms, are distinct from user specified keywords entered into a search engine in order to perform a search.

In addition, the advertiser specified criteria may include other demographic information about the user, such as the user's geographical location, age group or income group.

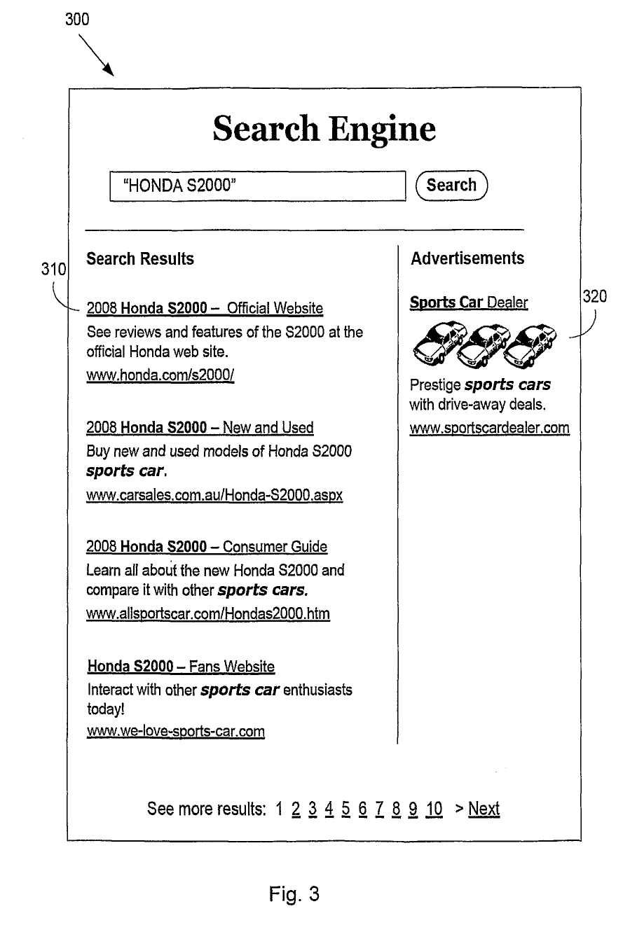

Search Engine Module 114 provides a user interface for users 140 to perform searches in various electronic formats. The interface may be a website dedicated to searching (see FIG. 3) or an embedded search tool on a third party website run by website operators 160. A user's query may be based on keywords, such as “HONDA CR-Z”, an image, a audio clip or a video clip.

To facilitate users queries, Search Engine Module 114 conducts regular analysis of electronic documents on the Internet using web-crawling techniques. An automatic script is scheduled to visit webpages, analyse images, audio files and video files on these webpages and follow hyperlinks from those webpages. A searchable index is then created and stored in the database 120 for later use by the Search Engine Module 114 in response to a user's query.

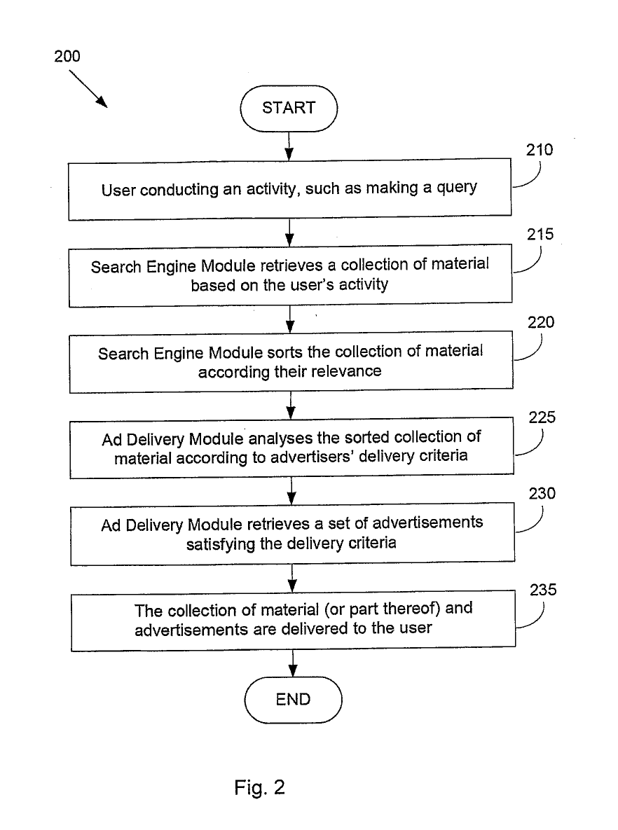

FIG. 2 is a flowchart of an advertisement delivery method 200 provided by the online advertising system 100. Upon receiving a user's query, Search Engine Module 114 will analyse the query, access the index in the database 120 based on the query, and retrieve a collection of material satisfying the query; see steps 210 and 215. The collection of material is sorted according to their relevance which depends on the quality of the electronic material; step 220.

If the user query is keyword-based, the relevance of an electronic document may depend on the number of times the keywords appear in the document. If the user query is image-based, the relevance of an electronic document may depend on the percentage match of the statistical properties of the input image with that of the electronic document.

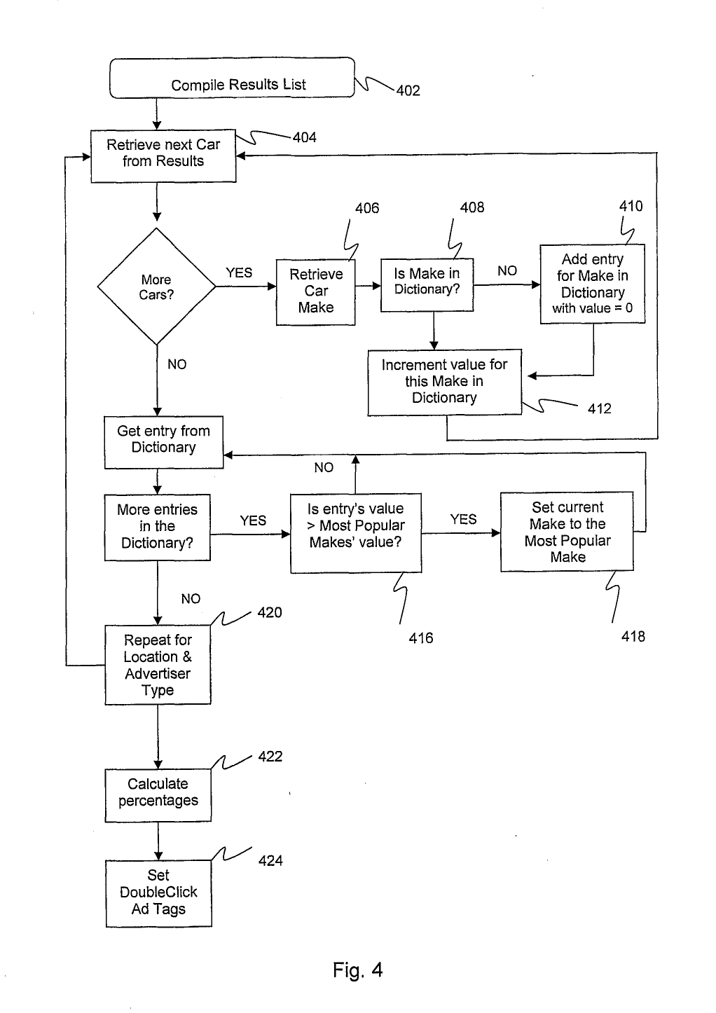

Ad Delivery Module 116 then analyses the collection of material based on the advertiser specified criteria to determine whether or not an advertisement is to be delivered to the user 140; step 225 in FIG. 2 (described in more detail with reference to FIG. 4). The analysis may be based on the entire collection, or a subset of the collection, preferably after the search results are sorted. The collection of material retrieved by the Search Engine Module 114 (or a portion thereof) and the advertisement or advertisements (assuming an advertisement is determined to be delivered) retrieved by Ad Delivery Module 116 are then sent to the user.

Billing Module 118 collects relevant statistics and calculates the associated advertising costs. Advertisers 150 may be charged according to the number of times their advertisements are clicked or viewed, or an activity is performed by the advertisement consumer 140. The former model is known as the Cost Per Click (CPC) model while the latter a Cost Per Impression (CPI) model. Other suitable pricing structures may be used, including Cost Per Activity (CPA), Cost Per Time (CPT), Cost Per Mille (CPM) and Cost Per Sale (CPS).

In a first example, a user query based on the input descriptor “HONDA S2000” will return a collection of webpages that are relevant to Honda S2000, a sports car. An advertiser may create an advertisement having the following fields using Ad Creation Module 112:

Title: Sports Car Dealer

Image: http://sportscardealer.com/cars.jpg

Text: Prestige sports cars with drive-away deals!

URL: http://www.sportscardealer.com

This particular advertiser, being a sports car dealer, is only interested in targeting a specific group of consumers who are looking for sports car, rather than car buyers in general. Ad Delivery Module 116 allows the advertiser to deliver advertisements based on words that appear in the search results, rather than the user's input keywords. This circumvents the problem of having to anticipate the user's search keywords, or to bid for keywords representing other sports car manufacturers or models in order to improve the advertisement coverage. If the content of the search results is not relevant, even if the user intended it to be, then the advertisement will not be shown.

In this case, the advertiser may specify to have the advertisement delivered if the field of information “SPORTS CAR” appears in the search results more than five times. Further, the proximity of these words should be taken into account. There should be no gap between “SPORTS” and “CAR” to eliminate search results having many independent instances of each word.

The advertiser could further specify to have only a percentage of the most relevant search results, such as the top 20%, analysed by the Ad Delivery Module 116. Another criteria might be the geographical location of the user performing the query so as to limit delivery of the advertisement to users within the same suburb, state or country. If the criteria specified are satisfied by the content of the collection of search results, the advertisement will be delivered to the user together with the search results.

In another example, a user performing a search enters the keywords “TOYOTA; 2004-2008; automatic”. This search returns a collection of search results in the form of web pages that are dynamically retrieved or generated based on these keywords. In this case, an advertiser such as a car dealer may purchase a search criteria with the field of information comprising: “cars under $10,000 in more than 50% of the search results” or “cars that are still under warranty”. Should the search results return vehicle pages where 60% of the vehicles referred to are under $10,000, the relevant advertisement would appear. Similarly, should the collection of search results refer to vehicles that are still under warranty, the relevant advertisement would also appear. In other words, the exemplified invention allows advertisers to a purchase criteria that is not directly related to the user selected keywords searched and instead, facilitates delivery of advertisements based on the content of the search results, rather than on the actual keywords which dynamically generated that content.

In addition, an advertiser may also purchase a criteria based on advertisements of other advertisers which are dynamically generated based on a user's search term. For example, a car insurance company may purchase criteria such as “car dealer” and delivery of an advertisement of a car dealer in the above scenario also results in delivery of an advertisement of the insurance company.

An exemplary interface 300 of the Search Engine Module 114 is shown in FIG. 3. A user query based on “HONDA S2000” returns a collection of URLs 310 and the advertisement 320 created by the advertiser. Of course, other sports car advertisers can also set similar criteria for the display of their advertisements on the search results page and bid for the top spot or spots on the first page of the results. Instances of “SPORTS CAR” in the search results 310 and advertisement 320 may be highlighted as shown in FIG. 3 to indicate the relevance of the advertisement to the user.

Alternatively, the search functionality provided by the Search Engine Module may be an embedded search tool on a third party's website 160. The embedded search tool allows search to be performed on that website. If the website's operator 160 has signed up to have advertisements displayed on the website, a search will prompt Ad Delivery Module 116 to analyse the search results according to criteria specified by advertisers and to deliver one or more advertisements whose criteria are met to the user. For example, a user performing a search on “HONDA S2000” on a car enthusiasts' website will result in delivery of the sports car dealer's advertisement if the above criteria are satisfied.

The online advertising system 100 is also operable to deliver advertisements based on image searching. For example, a user may enter “HONDA S2000” to look for images. To facilitate this type of search, Search Engine Module 114 extracts and stores feature vectors of images in the searchable index during web crawling. Ad Creation Module 112 will also need to perform feature extraction on the images provided by the advertiser when an advertisement is created. Upon receiving the query, Search Engine Module 114 retrieves a collection of images based on the searchable index. The feature vectors of images in the collection of search results are then compared with those of images provided by the advertiser by the Ad Delivery Module 116 upon receiving a user's query. In this case, the criteria for delivery of advertisement may be a percentage match of the images in the search results and a set of sports car images provided by the advertisers.

Similar analysis may be performed on video and voice clips to extract features that are representative of the content of the clips to facilitate searching and delivery of advertisements.

FIG. 4 illustrates a flow chart of the steps involved in the analysis of the collection of material which is carried out by Ad Delivery Module 116. In this example the collection of material is analysed and tagged according to the following advertiser specified criteria:

most popular MAKE of a vehicle,

LOCATION of a vehicle

ADVERTISER TYPE.

At step 402, the material from the retrieved search is scanned. The particular advertiser may have included as part of their advertiser specified criteria that only the top 20% of the collected material be considered. A list of vehicles contained in the scanned search material is then complied. Also complied is a geographic location associated with each vehicle (if one exists) and if an advertiser is associated with the vehicle a list of advertiser types is compiled.

At step 404, the first vehicle in the list is selected and assuming there are more vehicles in the list the MAKE of the selected car is retrieved, step 406. At step 408 the retrieved MAKE of the car is checked against a dictionary stored in the database 120. If an entry for the MAKE is not found in the dictionary, an entry for the MAKE is then added to the dictionary and its associated value is set to the default value of zero, step 410. At step 412, the value field for the MAKE is incremented to one as an entry for the MAKE is found. Otherwise if the MAKE is found in the dictionary then at step 412 its value is incremented by one.

The process then reverts back to step 404 and the above steps through to 412 are repeated until all the vehicles in the list have been processed and counted. At step 414, the first entry in the dictionary is retrieved and by default is set equal to the “most popular MAKE”. The subsequent entry is retrieved from the dictionary and at step 416 its associated value is compared against the value recorded against the “most popular MAKE”. If the value of the subsequent entry is greater than the value for the “most popular MAKE” then at step 418 the MAKE of the subsequent entry designated the “most popular MAKE”. Otherwise the next entry is retrieved from the dictionary. This process continues until all entries within the dictionary have been considered.

Should there be two or more MAKES with equal counts, the first found MAKE with the highest count is designated as the most popular MAKE.

At step 420, the process reverts back to step 404 and the above steps through to 418 are repeated, though this time processing and counting the geographic location associated with each vehicle. Once all the geographic locations in the list have been processed and counted the process again reverts back to step 404 where the same process is repeated for ADVERTISER TYPE.

At step 422, percentages are calculated for each MAKE of vehicle by dividing the count of the most popular MAKE with the number of vehicles on the list. Similarly percentages are calculated for each LOCTION in the list and each ADVERTISER TYPE in the list.

At step 424 double click Ad-tags are generated using the values for the most popular MAKE, LOCATION and ADVERTISER TYPE. For instance, an advertiser may have paid to have a particular advertisement delivered if the most popular car appearing in the totality of the search results is a Honda S2000. Similarly, an advertiser may have paid to have a particular advertisement delivered if the most frequently appearing location is, for example, Melbourne, Australia.

Whilst not shown in FIG. 4, if the search results had contained fields of information which matched a plurality of advertisements for display then the software may execute a precedence module. The determination of which, or in what order, to display different advertisements may be based on the revenue which the respective advertisements generate or potential revenue generated, or other criteria such as the likelihood (or unlikelihood) of matching.

Although the invention has been described with reference to particular examples, it should be appreciated that they could be exemplified in many other forms and in combination with other features not mentioned above. It should be appreciated that the invention is not limited to the type of electronic format and therefore any other electronic formats known to those skilled in the art could be utilised. For instance, the specified criteria may comprise multiple fields of information and each of these fields may be matched against the collection of material. For instance, an advertiser may specify a first field as being: “if 60% of the search results have cars with at least 6 air bags”, field 2: “if 65% of the search results have cars with a fuel economy of <7 litres per 100 km on a combined cycle” and field 3: “20% of the search results have cars with at least 6 air bags and 25% of the search results have cars with a fuel economy of <7 litres per 100 km on a combined cycle”. With this example the billing module may be set with $30cpm (cost per 1000 views) for field 1, $25cpm for field 2 and $150 cpm for field 3.

1. A computer implemented method of delivering advertisements online to an Internet user, the method comprising:
an advertiser specifying criteria for the delivery of an advertisement to an Internet user;
the user conducting activity on the Internet that results in a collection of material for delivery to the user; and
analysing the collection of material according to the advertiser specified criteria, and in the event the specified criteria are met delivering an advertisement specified by the advertiser together with the delivery of at least a portion of the collection of material.

2. The method according to claim 1 wherein the specified criteria comprises at least one field of information with the field of information being a set of words present either alone or in combination in the collection of material.

3. The method according to claim 2 wherein the specified criteria comprises an inequality associated with the set of words.

4. The method according to claim 3 wherein the specified criteria further comprises specifying a percentage of results that match the inequality.

5. The method according to claim 1 wherein the user's activity includes entering a search query, and where the collection of material includes the content of some web-pages retrieved in response to the search query.

6. The method according to claim 5 wherein the user's activity includes entering a search query and where the collection of material includes web-pages retrieved from a selection of the results of the search query.

7. The method according to claim 1 wherein the user's activity includes entering a search query and where the collection of material includes advertisements retrieved in response to the content of at least some web-pages retrieved based on the search query.

8. The method according to claim 1 wherein analysing the collection according to the specified criteria includes employing a web-crawling technique.

9. The method according to claim 8 wherein web-crawling is performed by a crawler which is adapted to maintain a lookup structure including a history of all URLs familiar to the crawler.

10. A system of delivering advertisements online to an Internet user, the system comprising:
a database to record advertiser specified criteria for the delivery of an advertisement to an Internet user; and
a server operable to:
retrieve a collection of material for delivery to a user, the collection of material resulting from the user having conducted activity on the Internet, and
analyse the collection of material according to the specified criteria, and in the event the advertiser specified criteria are met, to deliver an associated advertisement specified by the advertiser together with the delivery of at least a portion of the collection of material.

11. A system according to claim 10 wherein the advertiser specified criteria includes at least one field of information with the field of information being a set of words present either alone or in combination in the collection of material.

12. A system according to claim 11 wherein the advertiser specified criteria includes a set of words present in a percentage of the collection of material, or an analysis of how many times a particular word or words are repeated in the collection of material, or an inequality associated with the set of words.

13. (canceled)

14. A system according to claim 12 wherein the advertiser specified criteria comprises an inequality associated with the set of words and further comprises specifying a percentage of results that match the inequality.

15. (canceled)

16. A system according to claim 10 wherein the server comprises a search engine module which provides a user interface to enable users to perform searches.

17. A system according to claim 10 wherein the server comprises an advert creation module to enable advertisers to create advertisements.

18. A system according to claim 17 wherein advertisements are compiled using one or more electronic formats selected from text, image, audio and video.

19. A system according to claim 10 wherein the server comprises an advertising delivery module to deliver to the user the advertisement specified by the advertiser together with the delivery of the collection of material.

20. A system according to claim 10 wherein the database maintains a lookup structure including a history of all URLs visited during analysis of the collection of material.

21. A computer program product comprising a non-transitory computer usable storage medium embodying computer usable program code for delivering advertisements online to an Internet user, the computer program product comprising:
computer usable program code to record advertiser specifying criteria for the delivery of an advertisement to an Internet user;
computer usable program code to retrieve a collection of material for delivery to a user, the collection of material resulting from the user having conducted activity on the Internet, and to analyse the received collection of material according to the advertiser specifying criteria, and in the event the advertiser specifying criteria are met, to deliver an advertisement specified by the advertiser together with the delivery of at least a portion of the collection of material.

22. A computer program product according to claim 21 further comprising computer usable program code to generate an automatic script which is scheduled to visit web-pages and analyse the contents thereof, and computer usable program code to create a searchable look up structure of web-pages visited.

23. (canceled)
